(19) United States
(12) Patent Application Publication
(10) Pub. No.: US 2020/0041284 A1
(43) Pub. Date: Feb. 6, 2020

(54) MAP ROAD MARKING AND ROAD QUALITY COLLECTING APPARATUS AND METHOD BASED ON ADAS SYSTEM

(71) Applicant: WUHAN JIMU INTELLIGENT TECHNOLOGY CO., LTD., Wuhan, Hubei (CN)

(72) Inventors: Guohu LIU, Wuhan, Hubei (CN); Shuliang WANG, Wuhan, Hubei (CN); Duan XU, Wuhan, Hubei (CN); Jianwei CHENG, Wuhan, Hubei (CN)

(21) Appl. No.: 16/488,032

(22) PCT Filed: Feb. 12, 2018
(86) PCT No.: PCT/CN2018/076440

§ 371 Date: Aug. 22, 2019

(30) Foreign Application Priority Data
Feb. 22, 2017 (CN) 201710097560.7

(51) Int. Cl. G01C 21/32; G06K 9/00; G06T 7/73; G06T 7/00; G06T 7/40; G06F 16/29

(52) U.S. Cl. CPC G01C 21/32; G06K 9/00805; G06K 9/00798; G06T 7/73; G06T 2207/30256; G06T 7/40; G06F 16/29; G06T 2207/10024; G06T 2207/30261; G06T 7/0002

(57) ABSTRACT

A map road marking and road quality collecting device and method based on an ADAS system. The method includes step S1, a color image of a vehicle running road is acquired in real time, and lane markings and lane areas are extracted; step S2, feature point image coordinates of the lane markings are extracted, vehicle running position information is acquired in real time, and lane marking position information is obtained; step S3, lane indication markings and position information thereof are output; step S4, quality evaluation and position information of lanes are output; and step S5, map data are updated and supplemented in real time according to output results of steps S3 and S4.

### FIELD

The present disclosure relates to the technical field of automotive electronics, in particular to a map road marking and road quality collecting device and method based on an ADAS system.

### BACKGROUND

An advanced driver assistant system (ADAS), especially a vision-based ADAS system achieves LDW (lane departure warning), FCW (forward collision warning), PCW (pedestrian collision warning) and other warning functions during driving. In recent years, the ADAS market demands have increased rapidly. Originally, the systems were limited to the high-end market, and now the systems are entering the mid-market and are used more widely.

At present, the high precision road data collection operation is basically conducted through special map collection vehicles, the collection vehicles are provided with LiDAR and other equipment, consequently, the collection vehicles cost millions and millions and require specialized personnel and time. The collection of road quality, such as defects and flatness, is also achieved through the special collection vehicles, the collection vehicles are provided with multiple laser instruments and gratings for collection, the cost is high, and the operation efficiency is low due to specialized personnel operation.

### SUMMARY

The present disclosure aims to provide a map road marking and road quality collecting device and method based on an ADAS system in view of the defects of high quality and low efficiency in identifying road quality through equipment such as LiDAR in the prior art.

The technical solution adopted by the present disclosure for solving the technical problems is as follows.

The present disclosure provides a map road marking and road quality collecting device based on an ADAS system, comprising:

an image capture module for capturing a color image of a road in front of a running vehicle in real time;

an image preprocessing module for converting the color image into a grayscale image;

an ADAS module for identifying vehicle, pedestrian and obstacle areas in the grayscale image, conducting lane marking detection on the grayscale image, and outputting a feature point set and a linear equation of lane markings in the image and the lane areas of the lane markings in the image;

a lane marking position calculation module for conducting inverse perspective transformation on the feature point set of the lane markings to transform feature point image coordinates into coordinates of a physical world coordinate system centered on a camera, conducting curve fitting on feature points subjected to coordinate system transformation, and calculating lane marking position information;

a lane indication marking detection module for detecting lane direction function markings in the lane areas, including a go-straight marking, a left-turn marking, a right-turn marking, a turn-around marking and a go-straight and left-turn marking;

a lane defect detection module for obtaining a defect detection ROI area by excluding the identified vehicle, pedestrian and obstacle areas in all lane areas, detecting whether road defects exist in the defect detection ROI area according to the grayscale image in the defect detection ROI area, identifying defect types and evaluating road quality; and

a data processing module for extracting corresponding road defect information of the areas with the road defects, including defect type, road quality, position information and original image information, extracting the identified lane direction function markings and corresponding position information thereof, sending the road defect information and the lane direction function markings to a remote server in a wireless communication mode and dynamically updating and supplementing the map data in real time.

Further, the device comprises a sensor module for detecting acceleration in three orthogonal directions during running of the vehicle, and judging the bumpiness degree of the road according to the acceleration to obtain road bumpiness data and transmitting the road bumpiness data to the lane defect detection module, and the lane defect detection module outputs the road defect information according to the road bumpiness data and the grayscale image in the defect detection ROI area.

Further, the device comprises a positioning module for acquiring latitude and longitude information of the vehicle position in real time.

Further, the device comprises a storage module for caching data of all the modules and road image data, and a transmission module for communicating with the remote server.

The present disclosure provides a map road marking and road quality collecting method based on an ADAS system, comprising the following steps that:

S1, a color image of a vehicle running road is acquired in real time and processed into a grayscale image, and the vehicle-mounted ADAS system extracts the lane markings and the lane areas according to the grayscale image;

S2, feature point image coordinates of the lane markings are extracted and transformed into world coordinates, vehicle running position information is acquired in real time, and position information of the lane markings is obtained;

S3, road texture features in the grayscale image are extracted, texture identification is conducted on lane indication markings in the lane areas, and the lane indication markings and the position information thereof are output;

S4, according to the road texture features in the lane areas, the areas which do not conform to the normal road surface texture are primarily selected as the defective lane areas, sample training is conducted on the defective lane areas, and road defects are identified;

S5, the map data are updated and supplemented in real time according to output results of the S3 and S4.

Further, S4 further comprises the steps of acquiring acceleration information of three forward directions of the vehicle in real time as lane bumpiness information, evaluating the lane quality by combining the road defect identification results with the lane bumpiness information, and outputting the lane quality evaluation and position information thereof.

Further, the S1 specifically comprises the following substeps that

S11, a color image of a vehicle running road is obtained in real time;

S12, the color image is processed into a grayscale image;

S13, the grayscale image is subjected to binarization processing to obtain a binarized image including lane marking information;

S14, the binarized image is subjected to image segmentation, and pixel points of lane markings are extracted through a Hough Transform straight marking extraction method;

S15, the lane markings are primarily selected according to lane marking priori conditions including the length, width and color of the lane straight markings and the lane curve turning radius and width;

S16, the lane marking edge gradient values, namely the gray level difference value between the foreground pixel and the road background, the edge uniformity and the number of pixels are calculated and comprehensively used as lane marking confidence coefficient parameters, and primary selection results of the lane markings are further refined according to the confidence coefficients to obtain more accurate lane marking extraction results;

S17, the lane markings and lane areas are output.

Further, the S2 specifically comprises the following substeps that

S21, feature point image coordinates of the lane markings are extracted and transformed into world coordinates through a perspective transformation method;

S22, curve fitting is conducted on feature points of the lane markings in the world coordinates to obtain a curve equation of the lane markings;

S23, according to the world coordinates and the curve equation, the positions of the lane markings in the world coordinates are given;

S24, vehicle running position information is obtained in real time for locating the lane.

Further, the S3 specifically comprises the following substeps that

S31, road texture features in the lane grayscale image are extracted;

S32, indication markings are primarily identified according to the lane areas and the road texture features;

S33, a primary selection result with a higher weight is selected from primary selection results of the lane indication markings as the final indication marking identification result;

S34, the feature points are selected according to the final lane indication marking identification result, and the coordinates of the lane indication markings are calculated in combination with positioning data so as to determine the positions of the indication markings in the world coordinates;

S35, the lane indication markings and position information thereof are output.

Further, the S4 specifically comprises the following substeps that

S41, road texture features in the lane grayscale image are extracted, areas which do not conform to the normal road surface texture are selected as defective lane areas according to the road texture features in the lane areas;

S42, sample training is conducted on the defective lane areas to obtain a classifier for identifying road defects;

S43, three-axis acceleration information of the vehicle is collected in real time, vertical acceleration component is used as lane bumpiness information, and acceleration moments with large fluctuations are recorded and used as judgment basis of lane bumpiness;

S44, the lane quality is evaluated by combining the road defect identification results with the lane bumpiness information for determining the lane areas with quality defects;

S45, feature points in the lane defective areas determined in the S44 are selected, and coordinates of the areas are calculated in combination with the positioning data for determining position information of the areas in the world coordinates;

S46, lane defect results and position information thereof are output.

The device and the method have the beneficial effects that the map road marking and road quality collecting device and method based on the ADAS system are map road marking collection solutions which are easy to popularize, low in cost and timely in data updating and replace the solutions such as laser scanning vehicles with high cost and delayed in data updating, the cost is greatly reduced, updating is timely, special collection vehicles and special personnel operation are not needed, the road markings and road quality are collected simultaneously, the efficiency is greatly improved, and the cost is reduced.

### BRIEF DESCRIPTION OF THE DRAWINGS

The present disclosure will be further described below in conjunction with the accompanying drawings and embodiments, wherein,

FIG. 1 is a composition and structure schematic diagram of a device according to embodiments of the present disclosure;

FIG. 2 is an implementation functional diagram according to embodiments of the present disclosure;

FIG. 3 is a lane marking detection flow chart according to embodiments of the present disclosure;

FIG. 4 is a lane coordinate calculation flow chart according to embodiments of the present disclosure;

FIG. 5 is a lane indication marking detection flow chart according to embodiments of the present disclosure;

FIG. 6 is a lane defect detection block diagram according to embodiments of the present disclosure;

wherein, A1—Visual image module, A2—High-precision positioning module, A3—Multi-axis acceleration sensor, A4—Arithmetic unit, A41—Multi-thread processor CPU, A42—Parallel acceleration unit, A6—Communication module, A7—Storage module, A8—Display output module, 101—Image capture module, 102—Image preprocessing module, 103—ADAS module, 13A—other ADAS function modules, 13B—Lane marking detection module, 104—Sensor module, 105—Lane indication marking detection module, 106—Lane marking position calculation module, 107—Lane defect detection module, 108—Data processing module, 109—Storage module, 110—Transmission module.

### DETAILED DESCRIPTION OF THE EMBODIMENTS

In order to make the object, technical solution and advantages of the present disclosure clearer, the present disclosure will be further described in detail below in conjunction with the accompanying drawings and embodiments. It is understood that the specific embodiments described herein are merely illustrative of the present disclosure and are not intended to limit the present disclosure.

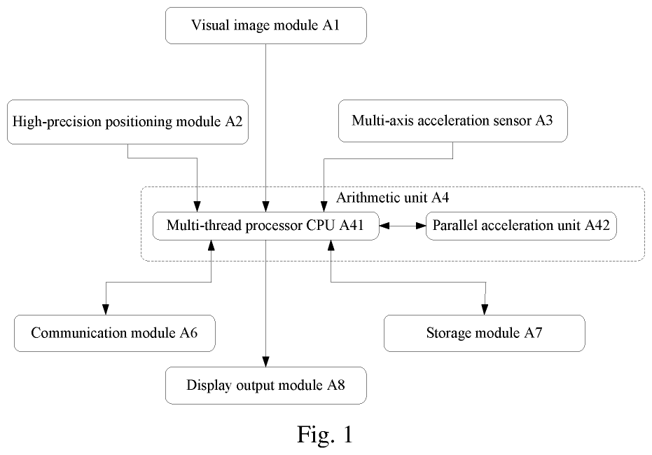

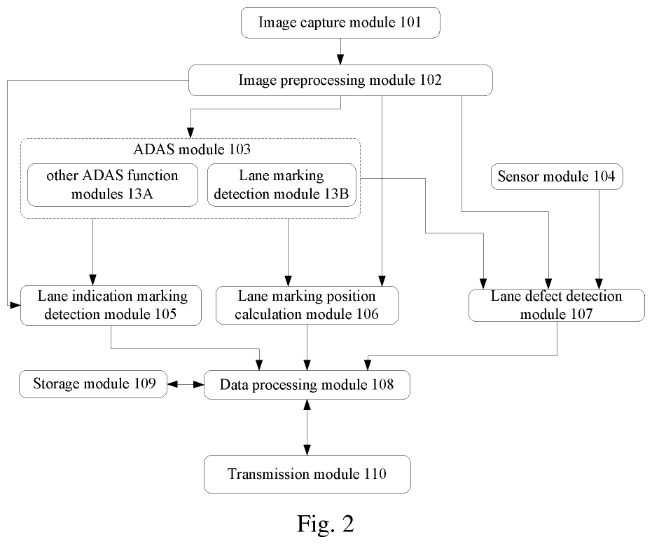

As shown in FIG. 1 and FIG. 2, the map road marking and road quality collecting device based on an ADAS system according to the embodiments of the present disclosure comprises:

an image capture module for capturing a color image of a road in front of a running vehicle in real time, wherein the image capture module is a monocular camera;

an image preprocessing module for converting the color image into a grayscale image;

an ADAS module for identifying vehicle, pedestrian and obstacle areas in the grayscale image, conducting lane marking detection on the grayscale image, and outputting a feature point set and a linear equation of lane markings in the image and the lane areas of the lane markings in the image;

a lane marking position calculation module for conducting inverse perspective transformation on the feature point set of the lane markings to transform feature point image coordinates into coordinates of a physical world coordinate system centered on a camera, conducting curve fitting on feature points subjected to coordinate system transformation, and calculating lane marking position information;

a lane indication marking detection module for detecting lane direction function markings in the lane areas, including a go-straight marking, a left-turn marking, a right-turn marking, a turn-around marking and a go-straight and left-turn marking;

a sensor module used for detecting the acceleration in three orthogonal directions in the vehicle running process and judging the road bumpiness degree according to the acceleration to obtain road bumpiness data;

a lane defect detection module for obtaining a defect detection ROI area by excluding the identified vehicle, pedestrian and obstacle areas in all lane areas, detecting whether road defects exist in the defect detection ROI area according to the road bumpiness data and the grayscale image in the defect detection ROI area, identifying defect types and evaluating road quality; and

a data processing module for extracting corresponding road defect information of the areas where the road defects exist, including defect type, road quality, position information and original image information, extracting the identified lane direction function markings and corresponding position information thereof, sending the road defect information and the lane direction function markings to a remote server in a wireless communication mode and dynamically updating and supplementing the map data in real time.

In another embodiment of the present disclosure, the device of the present disclosure is composed of the following components of:

1, a visual image module A1 for acquiring image sequences in real time through a monocular camera;

2, a high-precision positioning module A2 for accurately acquiring latitude and longitude information of the vehicle position in real time;

3, a multi-axis acceleration sensor A3 for determining motion data of the vehicle including the running direction and the running acceleration (speed);

4, an arithmetic unit A4 for comprehensively processing input of image information and motion information and obtaining road markings and road quality output for high-precision maps;

5, a multi-thread processor CPU A41 which is a component of the arithmetic unit A4 and is a key arithmetic processing unit;

6, a parallel acceleration unit A42 which is a component of the arithmetic unit A4 and used for accelerating operation of the multi-thread processor CPU A41 so that the operation efficiency can be improved, and the real-time performance of high-precision map output is met;

7, a communication module A6 for transmitting output results of all function modules to a server, and obtaining data from the server so as to compensate deficiency and defects of high-precision map output result information;

8, a storage module A7 for caching of high-precision map data;

9, a display output module A8 for transmitting collected lane marking position information, lane indication markings, road defects and other information to the remote server through 2G/3G/4G signals.

Based on the above modules, the device can achieve functions such as lane marking and position detection and road defect detection, and the functional modules are arranged as shown in FIG. 2.

The image capture module 101 is a monocular vision camera, and acquires a visual color image of a road in front of a vehicle in real time.

The image preprocessing module 102 converts the color image acquired by the image capture module 101 into a grayscale image so that the calculation dimension can be reduced, and the operation efficiency real-time performance is improved.

The ADAS module 103 includes other ADAS function modules 13A and the lane marking detection module 13B, wherein the other ADAS function modules 13A identify obstacles such as vehicles and pedestrians ahead and output the area of obstacles in the image. The other ADAS modules are not the key point of the present disclosure and will not be described in detail. The lane marking detection module 13B detects the lane markings and outputs a feature point set and a linear equation of the lane markings in the image and lane areas in the image.

The sensor module 104 is a three-axis acceleration sensor, detects the acceleration in three orthogonal directions in the vehicle running process, and can judge the road surface bumpiness degree.

The lane indication marking detection module 105 detects lane direction function markings in a lane, such as a go-straight marking, a left-turn marking, a right-turn marking, a turn-around marking and a go-straight and left-turn marking.

The lane marking position calculation module 106 can conduct inverse perspective transformation on the lane marking feature points output by the lane marking detection module 13B to transform feature point image coordinates of the lane markings into coordinates of a physical world coordinate system centered on a camera, conducts curve fitting on the feature points subjected to coordinate system transformation and can calculate the physical distance of the lane markings.

The lane defect detection module 107 obtains a defect detection ROI area by excluding the vehicle and obstacle areas detected by other ADAS function modules in all lane areas output by the lane marking detection module 13B, detects whether road defects exist in the defect detection ROI area in the image, detects whether road defects exist in the defect detection ROI area according to the road bumpiness data and the grayscale image in the defect detection ROI area, identifies defect types and evaluates road quality.

The data processing module 108 synthesizes and filters information such as lane marking position information, lane indication markings and road defects, transmits or caches the information.

The storage module 109 caches data of all the modules such as images and videos.

The transmission module 110 transmits the collected information such as lane marking position information, the lane indication markings and the road defects to the remote server through 2G/3G/4G signals, and exchanges other data.

The map road marking and road quality collecting method based on the ADAS system according to the embodiments of the present disclosure comprises the following steps.

S1, A color image of the vehicle running road is acquired in real time and processed into a grayscale image, and a vehicle-mounted ADAS system extracts the lane markings and the lane areas according to the grayscale image.

The S1 specifically comprises the following substeps that

S11, a color image of a vehicle running road is obtained in real time;

S12, the color image is processed into a grayscale image;

S13, the grayscale image is subjected to binarization processing to obtain a binarized image including lane marking information;

S14, the binarized image is subjected to image segmentation, and pixel points of lane markings are extracted through a Hough Transform straight marking extraction method;

S15, the lane markings are primarily selected according to lane marking priori conditions including the length, width and color of the lane straight markings and the lane curve turning radius and width;

S16, the lane marking edge gradient values, namely the gray level difference value between the foreground pixel and the road background, the edge uniformity and the number of pixels are calculated and comprehensively used as lane marking confidence coefficient parameters, and primary selection results of the lane markings are further refined according to the confidence coefficients to obtain more accurate lane marking extraction results;

S17, the lane markings and lane areas are output.

S2, Feature point image coordinates of the lane markings are extracted and transformed into world coordinates, vehicle running position information is acquired in real time, and position information of the lane markings is obtained.

The S2 specifically comprises the following substeps that

S21, feature point image coordinates of the lane markings are extracted and transformed into world coordinates through a perspective transformation method;

S22, curve fitting is conducted on feature points of the lane markings in the world coordinates to obtain a curve equation of the lane markings;

S23, according to the world coordinates and the curve equation, the positions of the lane markings in the world coordinates are given;

S24, vehicle running position information is obtained in real time for locating the lane.

S3, Road texture features in the grayscale image are extracted, texture identification is conducted on lane indication markings in the lane areas, and the lane indication markings and the position information thereof are output.

The S3 specifically comprises the following substeps that

S31, road texture features in the lane grayscale image are extracted;

S32, indication markings are primarily identified according to the lane areas and the road texture features;

S33, a primary selection result with a higher weight is selected from primary selection results of the lane indication markings as the final indication marking identification result;

S34, according to the final lane indication marking identification result, the feature points are selected, and the coordinates of the lane indication markings are calculated in combination with positioning data so as to determine the positions of the indication markings in the world coordinates;

S35, the lane indication markings and position information thereof are output.

S4, According to the road texture features in the lane areas, the areas which do not conform to the normal road surface texture are primarily selected as the defective lane areas, sample training is conducted on the defective lane areas, road defects are identified, three-axis acceleration information of a vehicle is collected in real time and used as lane bumpiness information, the lane quality is evaluated by combining the road defect identification results with the lane bumpiness information, and the lane quality evaluation and position information thereof are output.

The S4 specifically comprises the following substeps that

S41, road texture features in the lane grayscale image are extracted, areas which do not conform to the normal road surface texture are selected as defective lane areas according to the road texture features in the lane areas;

S42, sample training is conducted on the defective lane areas to obtain a classifier for identifying road defects;

S43, three-axis acceleration information of a vehicle is collected in real time, vertical acceleration component is used as lane bumpiness information, and acceleration moments with large fluctuations are recorded and used as judgment basis of lane bumpiness;

S44, the lane quality is evaluated by combining the road defect identification results with the lane bumpiness information for determining the lane areas with quality defects;

S45, feature points in the lane defective areas determined in the S44 are selected, and coordinates of the areas are calculated in combination with the positioning data for determining position information of the areas in the world coordinates;

S46, lane defect results and position information thereof are output.

S5, Map data are updated and supplemented in real time according to output results of the S3 and S4.

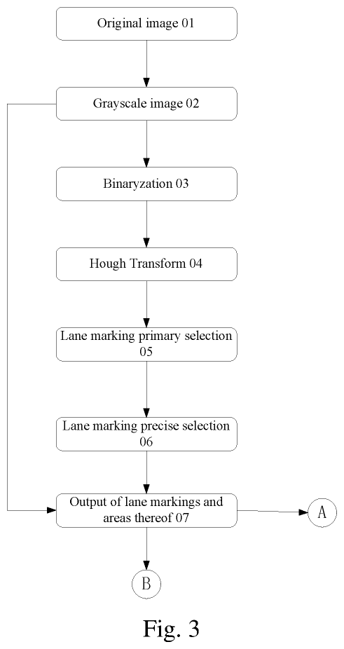

As shown in FIG. 3, in another embodiment of the present disclosure, the method comprises the following steps that

Step 01, image sequences containing road information are acquired in real time;

Step 02, a color image is subjected to grayscale processing;

Step 03, a grayscale image is subjected to binarization processing to obtain a binarized image containing abundant lane marking information;

Step 04, the binarized image is subjected to image segmentation, and pixel points of lane markings are extracted through a Hough Transform straight marking extraction method;

Step 05, the lane markings are primarily selected according to lane marking priori conditions such as the length, width and color of the straight markings and the curve turning radius and width;

Step 06, the lane marking edge gradient values (namely the gray level difference value between the foreground pixel and the road background), the edge uniformity, the number of pixels and other data are calculated and comprehensively used as lane marking confidence coefficient parameters, and primary selection results of the lane markings are further refined according to the confidence coefficients to obtain more accurate lane marking extraction results;

Step 07, the detection result of the lane markings and the area where the lane markings are located are output and provide data support for the lane marking related function, lane coordinates and road defects.

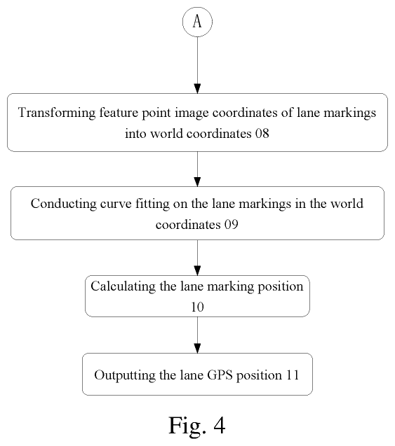

As shown in FIG. 4, based on the lane marking detection results, the function of outputting lane GPS position is achieved through the steps that

Step 08, pixel coordinates of the feature points of the lane markings are transformed into the world coordinates through a perspective transformation method;

Step 09, the feature points of the lane markings in the world coordinates are subjected to curve fitting to obtain a curve equation of the lane markings;

Step 10, the position of the lane in the world coordinates is given according to the world coordinates and the curve equation;

Step 11, the lane is located in combination with GPS data.

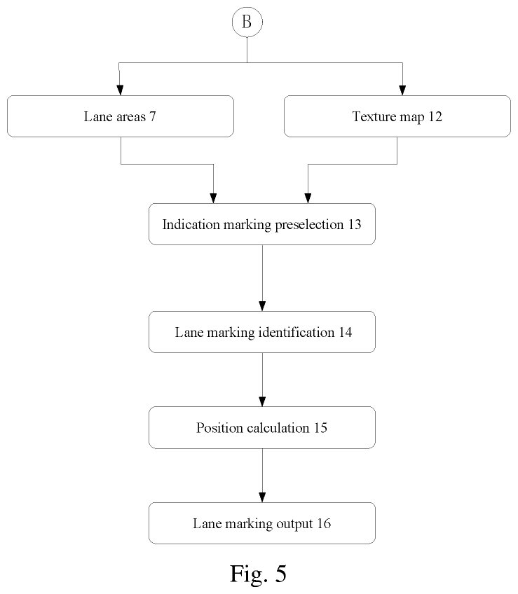

As shown in FIG. 5, based on the road detection results, the lane marking detection is conducted through the following steps that

Step 12, road marking texture features are extracted according to the image sequences;

Step 13, the lane areas are determined according to step 7, and the indication markings are primarily identified in combination with the texture features in step 12;

Step 14, a primary selection result with a higher weight is selected from primary selection results of the lane indication markings in step 13 as the final indication marking identification result;

Step 15, based on the lane indication markings determined in step 14, feature points are selected, and coordinates of the lane indication markings are calculated in combination with the positioning data so as to determine the position of the indication markings in world coordinates;

Step 16, lane indication marking position information is output.

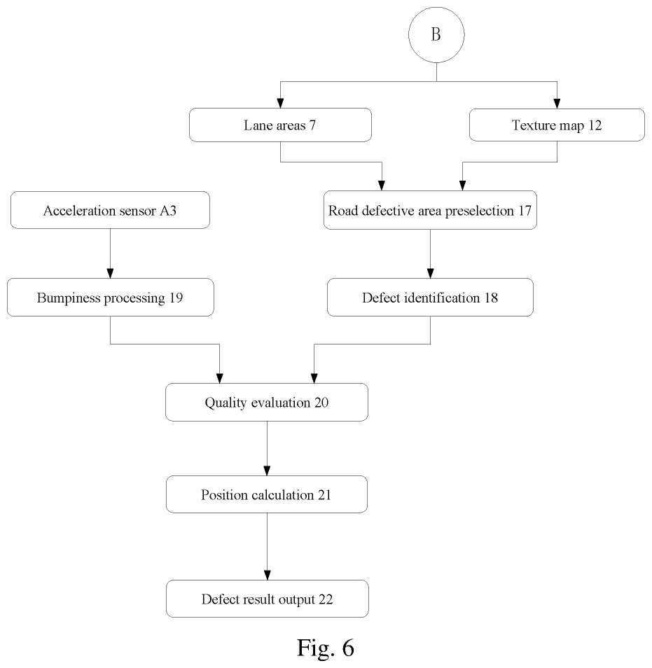

As shown in FIG. 6, according to lane image data and acceleration sensor data, lane quality detection can be achieved through the following steps that

Step 17, according to step 12 and step 7, the areas which do not conform to the normal road surface textures are primarily selected as the defective lane areas;

Step 18, the possible results of the defective road areas in step 17 are subjected to sample training to obtain a classifier for identifying the road defects;

Step 19, vertical component data of an acceleration sensor A3 are synchronously collected, and acceleration moments with large fluctuations are recorded and used as the judgment basis of lane bumpiness;

Step 20, the identification results of step 18 and step 19 are comprehensively considered for judging whether the lanes have quality defects or not;

Step 21, feature points in the areas with quality defects determined in step 20 are selected, and the coordinates of the areas are calculated in combination with the positioning data for determining position information of the areas in the world coordinates;

Step 22, defect results are output and sent to a server through a transmission module 110 for driving navigation.

The solution is integrated with the ADAS functions, and the ADAS equipment is lower in cost compared with that of collection vehicles and become increasingly popular, can be mounted and used in any ordinary vehicle easily. Dynamic real-time updating and supplementation of map data is achieved while the driving safety is improved in the daily normal driving process, map data and lane quality are collected simultaneously, on the premise that the accuracy and quality are ensured, the efficiency is greatly improved, and the cost is reduced.

A pattern recognition algorithm is adopted as the basic algorithm of currently-used high-precision positioning systems, with the improvement of computer computing performance and the improvement of a deep learning algorithm, the functions of the present disclosure can be achieved through the deep learning algorithm, namely CNN (a convolutional neural network), such as identification of lane indication markings, lane markings, street signs (speed limitation boards, forbidden markings and other road information indication markings). Thus, the algorithm is an alternative to the present disclosure and is not intended to be encompassed by the present disclosure.

The present disclosure has the following advantages that

1. The high-precision road marking data acquisition method is easy to popularize, low in cost and timely in data updating and is used for updating high-precision map data in real time. The road position accuracy can reach the 10CM level.

The following information can be collected:

(1) Lane markings (lane markings):

Position: transformed to longitude and latitude, accuracy can reach the 10CM level;

Width: lane marking width;

Type: single full markings, dotted markings and double markings;

Color: white and yellow;

Quality: contrast ratio and incomplete degree;

(2) Lane indication markings:

Lane driving direction: go-straight, left-turn, right-turn, turn-around and other identification classification and quality evaluation.

2. A road quality evaluation solution which is easy to popularize, low in cost and timely in data updating is used for guidance information for road maintenance, can also be used as supplement to map data and provides user-friendly forecasting prompts. For example, the road quality evaluation solution can be used for the occasions that a driver can be reminded before a vehicle runs to a road with poor quality when the road quality evaluation solution is used in an in-vehicle device such as a navigator.

Road quality: flatness;

Road defects: cracks, looseness, tracks, subsidence, upheaval and other defects.

It should be understood that for those skilled in the art, improvements or variations may be made according to the above description, and all such improvements and variations are intended to fall within the scope of protection of the appended claims.

1. A map road marking and road quality collecting device based on an ADAS system, comprising:
an image capture module for capturing a color image of a road in front of a running vehicle in real time;
an image preprocessing module for converting the color image into a grayscale image;
an ADAS module for identifying vehicle, pedestrian and obstacle areas in the grayscale image, conducting lane marking detection on the grayscale image, and outputting a feature point set and a line equation of lane markings in the image and the lane areas of the lane markings in the image;
a lane marking position calculation module for conducting inverse perspective transformation on the feature point set of the lane markings to transform image coordinates of the feature points of the lane markings into coordinates of a physical world coordinate system centered on a camera, conducting curve fitting on feature points subjected to coordinate system transformation, and calculating lane marking position information;
a lane indication marking detection module for detecting lane direction function markings in the lane areas, including a go-straight marking, a left-turn marking, a right-turn marking, a turn-around marking and a go-straight and left-turn marking;
a lane defect detection module for obtaining a defect detection ROI area by excluding the identified vehicle, pedestrian and obstacle areas in all lane areas, detecting whether road defects exist in the defect detection ROI area according to the grayscale image in the defect detection ROI area, identifying defect types and evaluating road quality; and
a data processing module for extracting corresponding road defect information of the areas with the road defects, including defect type, road quality, position information and original image information, extracting the identified lane direction function markings and corresponding position information thereof, sending the road defect information and the lane direction function markings to a remote server in a wireless communication mode and dynamically updating and supplementing the map data in real time.

2. The map road marking and road quality collecting device based on the ADAS system according to claim 1, wherein the device further comprises a sensor module for detecting acceleration in three orthogonal directions in the vehicle running process, and judging the bumpiness degree of the road according to the acceleration to obtain road bumpiness data and transmitting the road bumpiness data to the lane defect detection module, and the lane defect detection module outputs the road defect information according to the road bumpiness data and the grayscale image in the defect detection ROI area.

3. The map road marking and road quality collecting device based on the ADAS system according to claim 1, wherein the device further comprises a positioning module for acquiring latitude and longitude information of the vehicle position in real time.

4. The map road marking and road quality collecting device based on the ADAS system according to claim 1, wherein the device further comprises a storage module for caching data of all the modules and road image data, and a transmission module for communicating with a remote server.

5. A map road marking and road quality collecting method based on an ADAS system, comprising the following steps that:
S1, a color image of a vehicle running road is acquired in real time and processed into a grayscale image, and the vehicle-mounted ADAS system extracts the lane markings and the lane areas according to the grayscale image;
S2, feature point image coordinates of the lane markings are extracted and transformed into world coordinates, and vehicle running position information is acquired in real time to obtain position information of the lane markings;
S3, road texture features in the grayscale image are extracted, texture identification is conducted on lane indication markings in the lane areas, and the lane indication markings and the position information thereof are output;
S4, according to the road texture features in the lane areas, the areas which do not conform to the normal road surface texture are primarily selected as the defective lane areas, sample training is conducted on the defective lane areas, and road defects are identified; and
S5, the map data are updated and supplemented in real time according to output results of S3 and S4.

6. The map road marking and road quality collecting method based on an ADAS system according to claim 5, wherein S4 further comprises the steps of acquiring acceleration information of three forward directions of a vehicle in real time as lane bumpiness information, evaluating the lane quality by combining the road defect identification results with the lane bumpiness information, and outputting the lane quality evaluation and position information thereof.

7. The map road marking and road quality collecting method based on an ADAS system according to claim 5, wherein S1 specifically comprises the following substeps that:
S11, a color image of a vehicle running road is obtained in real time;
S12, the color image is processed into a grayscale image;
S13, the grayscale image is subjected to binarization processing to obtain a binarized image including lane marking information;
S14, the binarized image is subjected to image segmentation, and pixel points of lane markings are extracted through a Hough Transform straight marking extraction method;
S15, the lane markings are primarily selected according to lane marking priori conditions including the length, width and color of the lane straight markings and the lane curve turning radius and width;
S16, the lane marking edge gradient values, namely the gray level difference value between the foreground pixel and the road background, the edge uniformity and the number of pixels are calculated and comprehensively used as lane marking confidence coefficient parameters, and primary selection results of the lane markings are further refined according to the confidence coefficients to obtain more accurate lane marking extraction results; and
S17, the lane markings and lane areas are output.

8. The map road marking and road quality collecting method based on an ADAS system according to claim 5, wherein S2 specifically comprises the following substeps that:
S21, feature point image coordinates of the lane markings are extracted and transformed into world coordinates through a perspective transformation method;
S22, curve fitting is conducted on feature points of the lane markings in the world coordinates to obtain a curve equation of the lane markings is obtained;
S23, according to the world coordinates and the curve equation, the positions of the lane markings in the world coordinates are given; and
S24, vehicle running position information is obtained in real time for locating the lane.

9. The map road marking and road quality collecting method based on an ADAS system according to claim 5, wherein S3 specifically comprises the following substeps that:
S31, road texture features in the lane grayscale image are extracted;
S32, indication markings are primarily identified according to the lane areas and the road texture features;
S33, a primary selection result with a higher weight is selected from primary selection results of the lane indication markings as the final indication marking identification result;
S34, according to the final lane indication marking identification result, the feature points are selected, and the coordinates of the lane indication markings are calculated in combination with positioning data so as to determine the positions of the indication markings in the world coordinates; and
S35, the lane indication markings and position information thereof are output.

10. The map road marking and road quality collecting method based on an ADAS system according to claim 6, wherein S4 specifically comprises the following substeps that:
S41, road texture features in the lane grayscale image are extracted, areas which do not conform to the normal road surface texture are primarily selected as defective lane areas according to the road texture features in the lane areas;
S42, sample training is conducted on the defective lane areas to obtain a classifier for identifying road defects;
S43, three-axis acceleration information of a vehicle is collected in real time, vertical acceleration component is used as lane bumpiness information, and acceleration moments with large fluctuations are recorded and used as judgment basis of lane bumpiness;
S44, the lane quality is evaluated by combining the road defect identification results with the lane bumpiness information for determining the lane areas with quality defects;
S45, feature points in the lane defective areas determined in S44 are selected, and coordinates of the areas are calculated in combination with the positioning data for determining position information of the areas in the world coordinates;
S46, lane defect results and position information thereof are output.

11. The map road marking and road quality collecting method based on an ADAS system according to claim 6, wherein S1 specifically comprises the following substeps that:
S11, a color image of a vehicle running road is obtained in real time;
S12, the color image is processed into a grayscale image;
S13, the grayscale image is subjected to binarization processing to obtain a binarized image including lane marking information;
S14, the binarized image is subjected to image segmentation, and pixel points of lane markings are extracted through a Hough Transform straight marking extraction method;
S15, the lane markings are primarily selected according to lane marking priori conditions including the length, width and color of the lane straight markings and the lane curve turning radius and width;
S16, the lane marking edge gradient values, namely the gray level difference value between the foreground pixel and the road background, the edge uniformity and the number of pixels are calculated and comprehensively used as lane marking confidence coefficient parameters, and primary selection results of the lane markings are further refined according to the confidence coefficients to obtain more accurate lane marking extraction results; and
S17, the lane markings and lane areas are output.

12. The map road marking and road quality collecting method based on an ADAS system according to claim 6, wherein S2 specifically comprises the following substeps that:
S21, feature point image coordinates of the lane markings are extracted and transformed into world coordinates through a perspective transformation method;
S22, curve fitting is conducted on feature points of the lane markings in the world coordinates to obtain a curve equation of the lane markings is obtained;
S23, according to the world coordinates and the curve equation, the positions of the lane markings in the world coordinates are given; and
S24, vehicle running position information is obtained in real time for locating the lane.

13. The map road marking and road quality collecting method based on an ADAS system according to claim 6, wherein S3 specifically comprises the following substeps that:
S31, road texture features in the lane grayscale image are extracted;
S32, indication markings are primarily identified according to the lane areas and the road texture features;
S33, a primary selection result with a higher weight is selected from primary selection results of the lane indication markings as the final indication marking identification result;
S34, according to the final lane indication marking identification result, the feature points are selected, and the coordinates of the lane indication markings are calculated in combination with positioning data so as to determine the positions of the indication markings in the world coordinates; and
S35, the lane indication markings and position information thereof are output.

14. The map road marking and road quality collecting device based on the ADAS system according to claim 2, wherein the device further comprises a positioning module for acquiring latitude and longitude information of the vehicle position in real time.

15. The map road marking and road quality collecting device based on the ADAS system according to claim 2, wherein the device further comprises a storage module for caching data of all the modules and road image data, and a transmission module for communicating with a remote server.
